(19) United States
(12) Patent Application Publication
(10) Pub. No.: US 2003/0015253 A1
(43) Pub. Date: Jan. 23, 2003

(54) Router with improved safety system

(76) Inventors: Stephen F. Gass, Wilsonville, OR (US); J. David Fulmer, Tualatin, OR (US)

Correspondence Address: SD3, LLC, 22409 S.W. NEWLAND ROAD, WILSONVILLE, OR, 97070, US

(21) Appl. No.: 10/197,975

(22) Filed: Jul. 18, 2002

Related U.S. Application Data
(60) Provisional application No. 60/306,202, filed on Jul. 18, 2001.

(51) Int. Cl. B27C 1/00

(52) U.S. Cl. 144/154.5

(57) ABSTRACT

A router is described for cutting workpieces with router bits. The router includes a safety system configured to detect one or more dangerous conditions between a person and a router bit. The safety system includes a reaction subsystem configured to perform one or more predetermined actions in the event a dangerous condition is detected. In one embodiment, the safety system is configured to detect accidental contact between a person and the router bit, and then stop the rotation of the router bit to reduce potential injury to the person.

### CROSS-REFERENCE TO RELATED APPLICATIONS

This application claims the benefit of and priority from the following U.S. Provisional Patent Application, the disclosure of which is herein incorporated by reference: Serial No. 60/306,202, filed Jul. 18, 2001.

### FIELD OF THE INVENTION

The present invention relates to routers, and more particularly to a router with a high-speed safety system.

### BACKGROUND AND SUMMARY OF THE INVENTION

Routers are a type of woodworking machinery used to cut wood, plastic and other materials. Routers typically include a generally cylindrical housing enclosing a motor, and a rotatable shaft or spindle driven by the motor and extending from one end of the housing. A variety of router bits having different shapes are available and may be coupled to the shaft to perform different types of cuts. In some applications, a router is mounted to a rear side of a workpiece support surface so that the router bit extends through a hole in the support surface. A user then places a workpiece on the support surface and slides the workpiece against the router bit to cut the workpiece. In other applications, a base assembly is attached to the router to allow the router to be slid over the top of a workpiece. The router bit extends through a hole in the base assembly to cut the underlying workpiece. Routers present a risk of injury to users because the spinning router bit is usually exposed during use. Thus, any contact between a user's body and the spinning router bit can cause serious injury.

The present invention provides a router with an improved safety system that is adapted to detect the occurrence of one or more dangerous, or triggering, conditions during use of the router, such as when a user's body contacts the spinning router bit. When such a condition occurs, the safety system is actuated to limit or even prevent injury to the user.

### BRIEF DESCRIPTION OF THE DRAWINGS

FIG. 1 is a schematic block diagram of a router with a fast-acting safety system according to the present invention.

FIG. 2 is a schematic diagram of an exemplary safety system configured to stop the rotation of the router bit.

FIG. 3 is a schematic side elevation and partial cross-sectional view of a router with a safety system according to the present invention.

FIG. 4 is a close-up schematic side elevation of an alternative releasable coupling mechanism.

FIG. 5 is a close-up schematic side elevation of another alternative releasable coupling mechanism.

FIG. 6 is a schematic side elevation and partial cross-sectional view of a router with an alternative safety system according to the present invention.

FIG. 7 is a schematic side elevation and partial cross-sectional view of a router with another alternative safety system according to the present invention.

FIG. 8 is a partial schematic view showing an exemplary brake pawl and brake engagement structure.

FIG. 9 is a partial schematic view showing an alternative brake pawl and brake engagement structure.

FIG. 10 is a partial schematic view showing another alternative brake pawl and brake engagement structure.

FIG. 11 is a partial schematic view showing another alternative brake pawl and brake engagement structure.

FIG. 12 is a partial schematic view showing another alternative brake pawl and brake engagement structure.

FIG. 13 is a partial schematic view showing another alternative brake pawl and brake engagement structure.

### DETAILED DESCRIPTION AND BEST MODE OF THE INVENTION

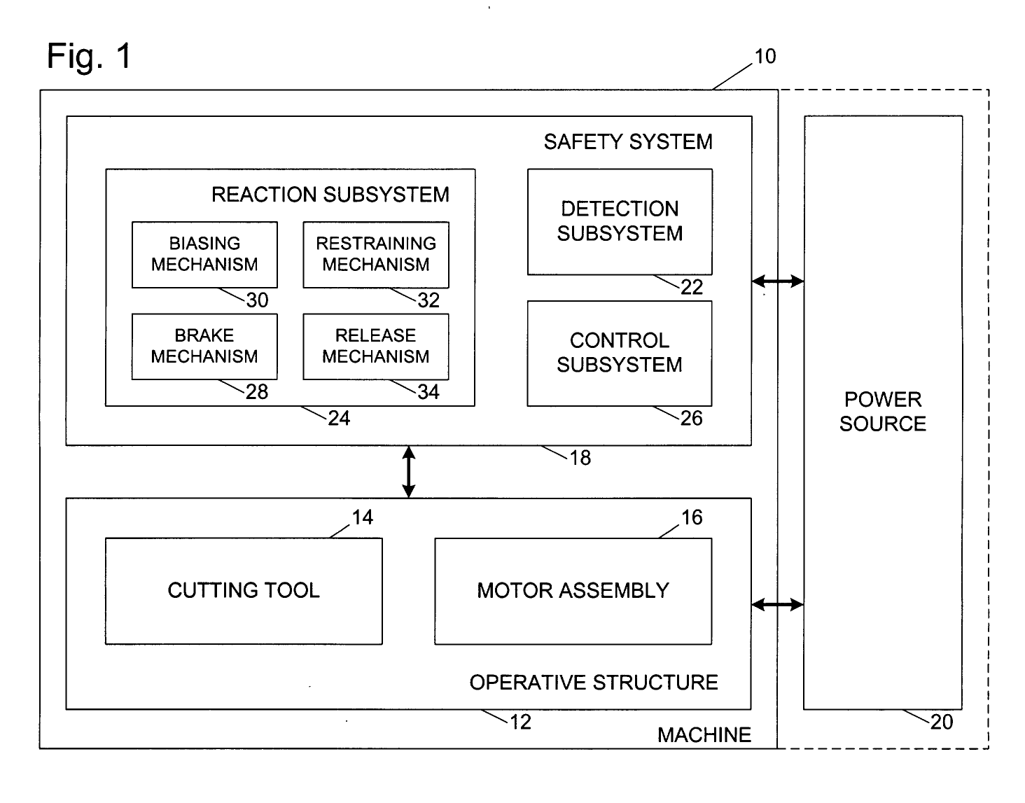

A router according to the present invention is shown schematically in FIG. 1 and indicated generally at 10. Router 10 may be any of a variety of different types and configurations of router adapted for cutting workpieces, such as wood, plastic, etc. Router 10 includes an operative structure 12 having a cutting tool 14 and a motor assembly 16 adapted to drive the cutting tool. Router 10 also includes a safety system 18 configured to minimize the potential of a serious injury to a person using router 10. Safety system 18 is adapted to detect the occurrence of one or more dangerous, or triggering, conditions during use of router 10. If such a dangerous condition is detected, safety system 18 is adapted to engage operative structure 12 to limit any injury to the user caused by the dangerous condition.

Router 10 also includes a suitable power source 20 to provide power to operative structure 12 and safety system 18. Power source 20 may be an external power source such as line current, or an internal power source such as a battery. Alternatively, power source 20 may include a combination of both external and internal power sources. Furthermore, power source 20 may include two or more separate power sources, each adapted to power different portions of router 10.

It will be appreciated that operative structure 12 may take any one of many different forms, depending on the type of router 10. As will be described in more detail below, operative structure 12 typically takes the form of a rotatable shaft configured to couple cutting tool 14 to motor assembly 16. The motor assembly includes one or more motors adapted to drive the cutting tool. The motors may be either directly or indirectly coupled to the cutting tool by operative structure 12.

Safety system 18 includes a detection subsystem 22, a reaction subsystem 24 and a control subsystem 26. Control subsystem 26 may be adapted to receive inputs from a variety of sources including detection subsystem 22, reaction subsystem 24, operative structure 12 and motor assembly 16. The control subsystem may also include one or more sensors adapted to monitor selected parameters of router 10. In addition, control subsystem 26 typically includes one or more instruments operable by a user to control the router. The control subsystem is configured to control router 10 in response to the inputs it receives.

Detection subsystem 22 is configured to detect one or more dangerous, or triggering, conditions during use of router 10. For example, the detection subsystem may be configured to detect that a portion of the user's body is dangerously close to, or in contact with, a portion of cutting tool 14. In some embodiments, detection subsystem 22 may inform control subsystem 26 of the dangerous condition, which then activates reaction subsystem 24. In other embodiments, the detection subsystem may be adapted to activate the reaction subsystem directly.

Once activated in response to a dangerous condition, reaction subsystem 24 is configured to engage operative structure 12 quickly to prevent serious injury to the user. It will be appreciated that the particular action to be taken by reaction subsystem 24 will vary depending on the type of router 10 and/or the dangerous condition that is detected. For example, reaction subsystem 24 may be configured to do one or more of the following: stop the movement of cutting tool 14, disconnect motor assembly 16 from power source 20, place a barrier between the cutting tool and the user, retract the cutting tool from its operating position, etc. The reaction subsystem may be configured to take a combination of steps to protect the user from serious injury. Placement of a barrier between the cutting tool and teeth is described in more detail in U.S. Provisional Patent Application Serial No. 60/225,206, filed Aug. 14, 2000, the disclosure of which is herein incorporated by reference. Retraction of the cutting tool from its operating position is described in more detail in U.S. Provisional Patent Application Serial No. 60/225,089, filed Aug. 14, 2000, the disclosure of which is herein incorporated by reference.

The configuration of reaction subsystem 24 typically will vary depending on which action(s) are taken. In the exemplary embodiment depicted in FIG. 1, reaction subsystem 24 is configured to stop the movement of cutting tool 14 and includes a brake mechanism 28, a biasing mechanism 30, a restraining mechanism 32, and a release mechanism 34. Brake mechanism 28 is adapted to engage operative structure 12 under the urging of biasing mechanism 30. During normal operation of router 10, restraining mechanism 32 holds the brake mechanism out of engagement with the operative structure. However, upon receipt of an activation signal by reaction subsystem 24, the brake mechanism is released from the restraining mechanism by release mechanism 34, whereupon, the brake mechanism quickly engages at least a portion of the operative structure to bring the cutting tool to a stop.

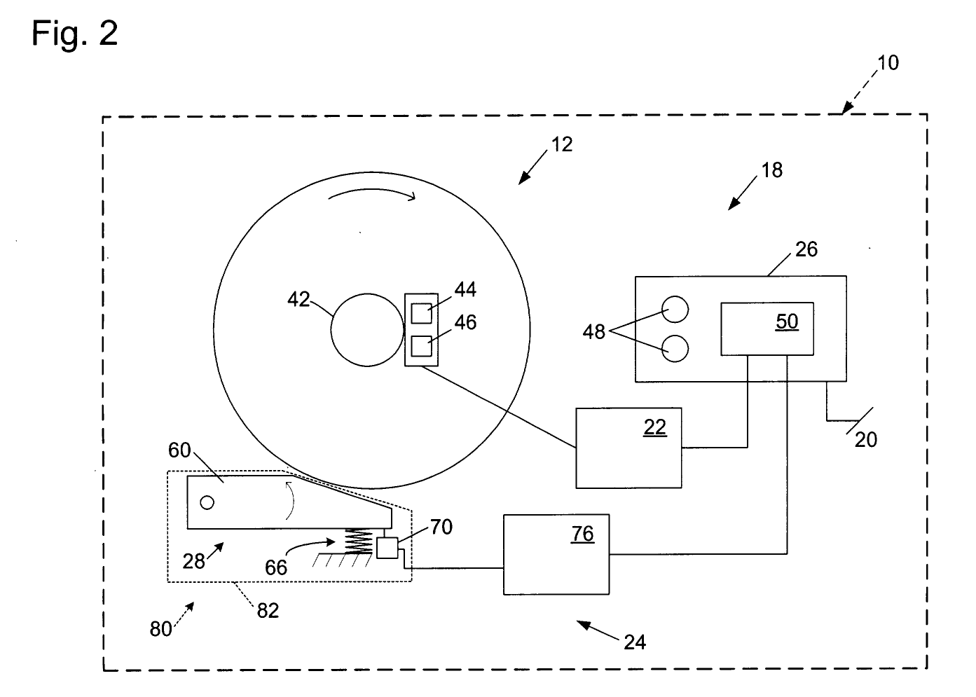

It will be appreciated by those of skill in the art that the exemplary embodiment depicted in FIG. 1 and described above may be implemented in a variety of ways depending on the type and configuration of operative structure 12. Turning attention to FIG. 2, one example of the many possible implementations of router 10 includes an operative structure having a motor-driven spindle 42, and a generally circular brake engagement structure 43 concentrically coupled to the spindle. During operation, any standard router bit (not shown) or other cutting tool is also coupled to the spindle. As described in more detail below, brake mechanism 28 is adapted to engage brake engagement structure 43 and stop the rotation of both the brake engagement structure and the router bit. Alternatively, the brake engagement structure may be integrally formed with the router bit to form a unitary element.

In the exemplary implementation, detection subsystem 22 is adapted to detect the dangerous condition of the user coming into contact with the router bit. The detection subsystem includes a sensor assembly, such as contact detection plates 44 and 46, which are capacitively coupled to the router bit to detect any contact between the router bit and a user's body. Typically, the router bit, or some larger portion of operative structure 12, is electrically isolated from the remainder of router 10. Alternatively, detection subsystem 22 may include a different sensor assembly configured to detect contact in other ways, such as optically, resistively, etc. In any event, the detection subsystem is adapted to transmit a signal to control subsystem 26 when contact between the user and the blade is detected. Various exemplary embodiments and implementations of detection subsystem 22 are described in more detail in U.S. Provisional Patent Application Serial No. 60/225,200, filed Aug. 14, 2000, U.S. Provisional Patent Application Serial No. 60/225,211, filed Aug. 14, 2000, U.S. Provisional Patent Application Serial No. 60/270,011, filed Feb. 20, 2001, and U.S. Provisional Patent Application Serial No. 60/298,207, filed Jun. 13, 2001, the disclosures of which are herein incorporated by reference. Alternatively, U.S. Provisional Patent Application Serial No. 60/302,937, filed Jul. 2, 2001, the disclosure of which is herein incorporated by reference, describes various embodiments of detection subsystem 22 configured to detect dangerous proximity between a person and the router bit.

Control subsystem 26 includes one or more instruments 48 that are operable by a user to control the motion of the router bit. Instruments 48 may include start/stop switches, speed controls, direction controls, etc. Control subsystem 26 also includes a logic controller 50 connected to receive the user's inputs via instruments 48. Logic controller 50 is also connected to receive a contact detection signal from detection subsystem 22. Further, the logic controller may be configured to receive inputs from other sources (not shown) such as router bit motion sensors, workpiece sensors, etc. In any event, the logic controller is configured to control operative structure 12 in response to the user's inputs through instruments 48. However, upon receipt of a contact detection signal from detection subsystem 22, the logic controller overrides the control inputs from the user and activates reaction subsystem 24 to stop the motion of the router bit. Various exemplary embodiments and implementations of control subsystem 26 are described in more detail in U.S. Provisional Patent Application Serial No. 60/225,059, filed Aug. 14, 2000 and U.S. Provisional Patent Application Serial No. 60/225,094, filed Aug. 14, 2000, the disclosures of which are herein incorporated by reference.

In the exemplary implementation shown in FIG. 2, brake mechanism 28 includes a brake pawl 60 mounted adjacent the edge of brake engagement structure 43 and selectively moveable to engage and grip the brake engagement structure. As will be described in more detail below, pawl 60 may be constructed of any suitable material adapted to engage and stop the brake engagement structure. It will be appreciated that the construction of pawl 60 will vary depending on the configuration of brake engagement structure 43. In any event, the pawl is urged against the brake engagement structure by a biasing mechanism such as a spring 66. It should be understood that sliding or rotary movement of pawl 60 may also be used. The spring is adapted to urge pawl 60 against the brake engagement structure with sufficient force to grip the brake engagement structure and quickly bring it to a stop, thereby stopping the rotation of the router bit.

The pawl is held away from the edge of the brake engagement structure by a restraining mechanism such as a fusible member 70. The fusible member is constructed of a suitable material adapted to restrain the pawl against the bias of spring 66, and also adapted to melt under a determined electrical current density. Examples of suitable materials for fusible member 70 include NiChrome wire, stainless steel wire, etc. The fusible member is connected between the pawl and a contact mount 72. Preferably, fusible member 70 holds the pawl relatively close to the edge of the brake engagement structure to reduce the distance pawl 60 must travel to engage the brake engagement structure. Positioning the pawl relatively close to the edge of the brake engagement structure reduces the time required for the pawl to engage and stop the brake engagement structure. Typically, the pawl is held approximately 1/32-inch to ¼-inch from the edge of the brake engagement structure by fusible member 70; however, other spacings may also be used within the scope of the invention.

Pawl 60 is released from its unactuated, or cocked, position to engage the router bit by a release mechanism in the form of a firing subsystem 76. The firing subsystem is coupled to contact mount 72, and is configured to melt fusible member 70 by passing a surge of electrical current through the fusible member. Firing subsystem 76 is coupled to logic controller 50 and activated by a signal from the logic controller. When the logic controller receives a contact detection signal from detection subsystem 22, the logic controller sends an activation signal to firing subsystem 76, which melts fusible member 70, thereby releasing the pawl to stop the blade. Various exemplary embodiments and implementations of reaction subsystem 24 are described in more detail in U.S. Provisional Patent Application Serial No. 60/225,056, filed Aug. 14, 2000, U.S. Provisional Patent Application Serial No. 60/225,169, filed Aug. 14, 2000, and U.S. Provisional Patent Application Serial No. 60/225,170, filed Aug. 14, 2000, the disclosures of which are herein incorporated by reference.

In some embodiments, activation of the brake mechanism may require the replacement of one or more portions of safety system 18. For example, pawl 60 and fusible member 70 typically are single-use components which must be replaced before the safety system is ready to be used again. Thus, it may be desirable to incorporate one or more portions of safety system 18 in a cartridge that can be easily replaced. For example, in the exemplary implementation depicted in FIG. 2, safety system 18 includes a replaceable cartridge 80 having a housing 82. Pawl 60, spring 66, fusible member 70 and contact mount 72 are all mounted within housing 82. Alternatively, other portions of safety system 18 may be mounted within the housing. In any event, after the reaction system has been activated, the safety system can be reset by replacing cartridge 80. The portions of safety system 18 not mounted within the cartridge may be replaced separately or reused as appropriate. Various exemplary embodiments and implementations of a safety system using a replaceable cartridge are described in more detail in U.S. Provisional Patent Application Serial No. 60/225,201, filed Aug. 14, 2000 and U.S. Provisional Patent Application Serial No. 60/225,212, filed Aug. 14, 2000, the disclosures of which are herein incorporated by reference.

In the exemplary embodiment depicted in FIG. 2 and described above, brake mechanism 28 is configured to stop the rotation of the spindle and at least a portion of the motor assembly (e.g., armature, etc.) as well as the router bit. While this configuration has the advantage of simplicity of design, it may require a larger brake pawl to absorb the energy of the spinning spindle and motor armature which are relatively heavy compared to the router bit. Thus, it may be desirable to decouple the router bit from the spindle and motor during braking. This may allow a smaller brake pawl to be used, and may reduce strain on the motor assembly.

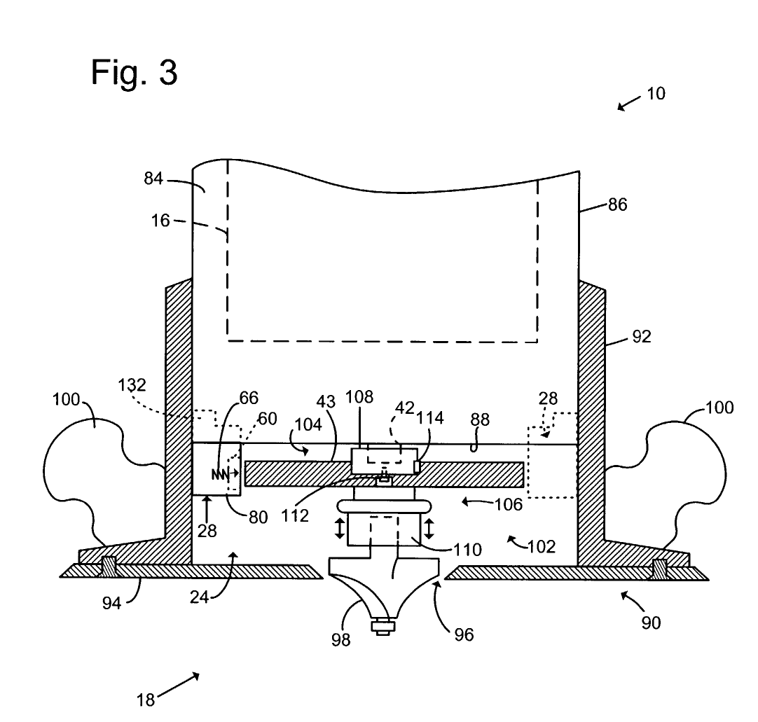

One exemplary configuration of router 10 in which the router bit may be selectively uncoupled from the motor is depicted in FIG. 3. Router 10 includes a main housing 84 enclosing a motor assembly 16. Typically, housing 84 is generally cylindrical having generally circular sides 86 extending from a lower end 88 to an upper end (not shown). Alternatively, housing 84 may be any desired shape or configuration. A rotatable spindle 42 is coupled to the motor assembly and extends through an opening in lower end 88. The motor assembly is adapted to drive the spindle at rotational speeds typically between 3,000 and 30,000 rpm, although other speeds may also be used. Optionally, router 10 may include a variable speed control to allow an operator to select a desired speed.

As shown in FIG. 3, router 10 is coupled to a base assembly 90 adapted to stably support the router on a surface of a workpiece. Base assembly 90 may be any of a variety of base assemblies such as are known in the art. The base assembly typically includes a generally cylindrical shell 92 adapted to fit over, or otherwise couple to, housing 84 adjacent the lower end. Shell 92 may be coupled to housing 84 using a friction fit coupling, or any other suitable mechanism such as screws, etc. The shell extends beyond the lower end to at least partially enclose spindle 42. Portions of shell 92 may be open or transparent to allow an operator to view the area of a workpiece being cut during operation. The axial position of shell 92 relative to housing 84 typically is adjustable to allow the operator to select the distance the base assembly extends beyond the lower end. Optionally, the base assembly may include a support plate 94 mounted to the end of shell 92, and adapted to slide against the surface of a workpiece. Support plate 94 includes an opening 96 which is generally axially aligned with spindle 42, and which is sized to allow the passage of a router bit 98. Base assembly 90 may also include one or more handle members 100 adapted to be gripped by an operator to move the router over the workpiece.

As is well known to those of skill in the art, base assembly 90 is typically used to allow an operator to slide the router over the surface of a stationary workpiece while cutting material from a lateral edge of the workpiece. Alternatively, router 10 may be mounted to the underside of a router table or similar support structure (not shown) so that the router bit extends through a work surface adapted to support a workpiece. In this latter configuration, the operator slides the workpiece over the work surface and against the router bit to cut the workpiece. It will be appreciated by those of skill in the art that safety system 18 may be used with router 10 regardless of whether the router is coupled to base assembly 90 or a router table, etc. Furthermore, while one particular housing assembly has been described above, it will be appreciated that safety system 18 may be adapted as necessary for use with any type of housing assembly.

In the exemplary implementation depicted in FIG. 3, router bit 98 is coupled to spindle 42 through a releasable coupling assembly 102. Releasable coupling assembly 102 is adapted to couple the router bit to the spindle in an axially- and rotationally-fixed position concentric with the spindle. Thus, the motor assembly is indirectly coupled to rotationally drive the router bit through spindle 42 and releasable coupling assembly 102. During normal operation, the releasable coupling assembly imparts the rotation of the spindle to the router bit. However, during braking, the releasable coupling assembly is configured to rotationally uncouple the router bit from the motor assembly so that the router bit may be braked while the motor continues to spin. In other words, releasable coupling assembly 102 is a torque-limiting coupling configured to at least temporarily uncouple the router bit from the motor assembly in response to a high torque load on the router bit and/or releasable coupling assembly. Releasable coupling assembly 102 typically is configured to retain the router bit axially coupled to the spindle or motor assembly to prevent the router bit from leaving the spindle and possibly causing damage to the router or injury to the operator.

It will be appreciated that releasable coupling assembly 102 may be configured to rotationally uncouple the router bit in a variety of different ways such as are known to those of skill in the art. For example, the exemplary releasable coupling assembly depicted in FIG. 3 includes a first or fixed section 104 and a second or releasable section 106. First section 104 is rigidly coupled to the end of spindle 42 that extends out of housing 84. First section 104 includes a cylindrical fitting or cap 108 with an open end threadedly mounted on spindle 42. The direction of the threaded coupling between the spindle and cap 108 may be selected, relative to the rotational direction of the spindle, so that the cap is self-tightening onto the spindle during operation.

Second section 106 is coupled to first section 104 through both an axial coupling mechanism and a rotational coupling mechanism. While the axial coupling mechanism is configured to hold second section 106 securely to first section 104, the rotational coupling mechanism is configured to self-release under specified torque loads. Second section 106 includes a brake engagement structure 43 and a router bit collet or chuck 110. Brake engagement structure 43 is generally disk-shaped with a central bore on one end adapted to fit at least partially over cap 108. The opposing end of brake engagement structure 43 includes a recess adapted to receive a bolt 112, which extends through a hole in the brake engagement structure to threadedly engage the closed end of cap 108. Thus, bolt 112 serves as the axial coupling mechanism to axially couple the brake engagement structure 43 to cap 108. Alternatively, any other suitable mechanism may be used to axially couple the brake engagement structure to the cap.

As mentioned above, cap 108 has a generally cylindrical exterior surface allowing the brake engagement structure to rotate relative to cap 108. Thus, bolt 112 does not rotationally couple brake engagement structure 43 to cap 108. Rather, the brake engagement structure is rotationally coupled to the cap by a releasable coupling member in the form of a shear pin 114. As shown in FIG. 3, shear pin 114 is positioned within aligned recess regions formed in the circular adjoining faces of cap 108 and brake engagement structure 43. Thus, shear pin 114 imparts the rotation of the cap to the brake engagement structure. Alternatively, a plurality of shear pins may be used to rotationally couple the brake engagement structure to the cap. As a further alternative, other types of releasable coupling elements may be used.

As is well known to those of skill in the art, shear pin 114 is a torque-limiting coupling device that will shear off, or release, at a predetermined shearing force proportional to the torque between the brake engagement structure and the cap. The amount of torque required to shear the shear pin will vary depending on the configuration of the shear pin (i.e., size, shape, material, hardness, etc.). Typically, the configuration of shear pin 114 is selected to ensure shearing only in response to a threshold torque corresponding to the engagement of a brake pawl or other braking component with the brake engagement structure. Thus, shear pin 114 will not shear under normal operating conditions. However, once the brake pawl engages the brake engagement structure, shear pin 114 will shear, thereby releasing brake engagement structure 43 to rotate freely about cap 108. This releases the rotational coupling between the router bit and the motor assembly and spindle so that the rotation of the router bit can be stopped without stopping the motor and spindle.

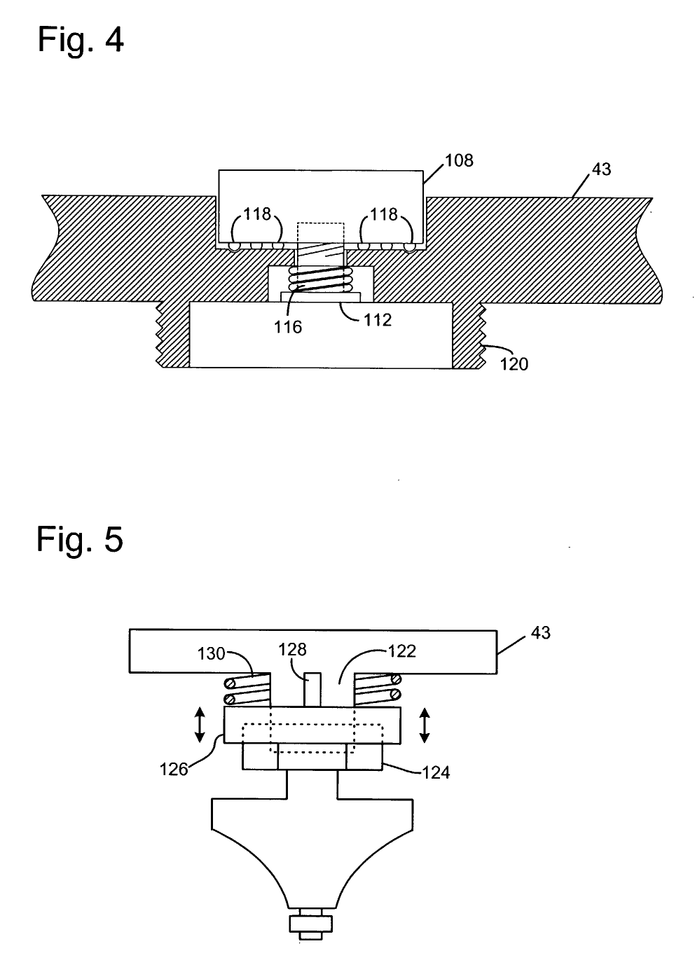

While shear pin 114 has been described above as one example of a releasable, rotational coupling between the router bit and the spindle or motor, it will be appreciated that any of a variety of alternative mechanisms may be used. As another example, brake engagement structure 43 and router bit 98 may be coupled to spindle 42 by a releasable coupling that automatically re-couples the router bit to the spindle once the torque load decreases to a predetermined level. One example of such a coupling is illustrated in FIG. 4. As shown, brake engagement structure 43 is coupled to cap 108 by a spring-loaded, torque-limiting coupling assembly. The shank of bolt 112 passes through brake engagement structure 43 to threadedly engage cap 108. A compression spring 116 is disposed around the shank of the bolt between the brake engagement structure and the head of the bolt. Spring 116 urges the brake engagement structure and cap tightly together. A plurality of ball bearings 118 are disposed between the cap and brake engagement structure, and normally sit in recesses in the surfaces of the cap and brake engagement structure. Alternatively, the cap and/or the brake engagement structure may have one or more circular tracks of alternating ridges and depressions which the ball bearings may be seated in.

During normal operation, the brake engagement structure is rotationally coupled to the cap by ball bearings 118, which are held in the recesses by the compressive force exerted by spring 1 16. However, upon application of sufficient torque, ball bearings 118 will roll out of the recesses, allowing the brake engagement structure to rotate relative to the cap. The amount of torque necessary to unseat the ball bearings (the “decoupling-torque threshold”) will depend on the compressive force exerted by spring 116. Thus, spring 116 may be selected to yield a desired decoupling-torque threshold. Optionally, suitable alignment structure (not shown) may be disposed between the brake engagement structure and cap to maintain the ball bearings in a concentric path about bolt 112. In such case, the ball bearings would continually roll into and out of the recesses until the applied torque decreased below a threshold level, at which point the ball bearings would reseat into the recesses, thereby re-coupling the brake engagement structure to the cap. It will be appreciated that the torque threshold level at which the ball bearings will be unseated may be the same as, or different than, the torque threshold level at which the unseated ball bearings will be reseated. While the exemplary releasable coupling depicted in FIG. 3 may be less expensive to manufacture, the exemplary coupling depicted in FIG. 4 has the advantage of not requiring replacement of a shear component to return the router to normal operation after the brake mechanism has been triggered to stop the router bit.

The exemplary coupling depicted in FIG. 4 is a relatively simple version of a variety of torque-limiting couplers known in the art. Any of these couplers may be used to releasably couple the router bit to the spindle and motor assembly. A few examples of the many such suitable couplers, showing just a few of the possible configurations, are described in the following U.S. patents, the disclosures of which are herein incorporated by reference: U.S. Pat. No. 4,898,249 to Ohmori, U.S. Pat. No. 5,738,469 to Hsu, U.S. Pat. No. 5,277,527 to Yokota, and U.S. Pat. No. 6,045,303 to Chung. Additionally, any other suitable torque-limiting coupler such as are known in the art may be used.

Returning attention to FIG. 3, chuck 110 is axially and rotationally coupled to brake engagement structure 43 by any suitable coupler mechanism. In the exemplary implementation, chuck 110 and brake engagement structure 43 are formed as an integral, unitary assembly. This ensures that the chuck and router bit remain securely coupled to the brake engagement structure during braking. Alternatively, chuck 110 may be coupled to brake engagement structure 43 by any known mechanism adapted to securely hold the chuck and brake engagement structure together during both operation and braking. For example, the exemplary brake engagement structure depicted in FIG. 4 includes an externally threaded ring 120 adapted to engage a matching threaded bore on chuck 110. Optionally, the threaded bore on the chuck may be a different size than the threaded end of spindle 42 to prevent an operator from inadvertently attaching the chuck to the spindle without the brake engagement structure. Alternatively, ring 120 may be internally threaded to receive a matching threaded post (not shown) on chuck 110. As will be described in more detail below, either chuck 110 or brake engagement structure 43 may include a locking mechanism to prevent inadvertent loosening during operation or braking.

Chuck 110 may be any suitable router chuck configured to securely hold router bit 98 during both normal operation and during braking. In the exemplary implementation, chuck 110 is a quick-release router chuck such as is available from Jacobs of Clemson, S.C. under the designation HAND-TITE, POWERCOLLET, router chuck. Other suitable chucks are described in the following U.S. patents, the disclosures of which are herein incorporated by reference: U.S. Pat. No. 5,755,448 to Kanaan et al., U.S. Pat. No. 5,820,136 to Han et al., U.S. Pat. No. 5,921,563 to Huggins et al., and U.S. Pat. No. 5,947,484 to Huggins et al.

FIG. 5 illustrates an alternative mechanism for coupling router bit 98 to brake engagement structure 43. As shown, brake engagement structure 43 is formed to define a collet 122 adapted to receive router bit 98. A collet nut 124 threadedly engages the outer surface of collet 122 to tighten the collet around the router bit as is well known in the art. However, depending on the direction of the threads on collet 122, collet nut 124 may tend to self-loosen either during normal operation or during braking. Therefore, the coupling mechanism also includes a spring-loaded locking member 126 disposed around the collet, and adapted to extend at least partially around the sides of collet nut 122. The locking member includes a projecting key (not shown) adapted to slide along an axial channel 128 in collet 122. Thus, the locking member is rotationally fixed to the collet. A compression spring 130 is positioned around the collet between the brake engagement structure and the locking member to bias the member toward collet nut 124. Locking member 126 includes an internal bore shaped to correspond to, and fit around, the external shape of the nut (e.g., hexagonal, octagonal, etc.). As a result, when locking member 126 is slid over collet nut 124, the collet nut is prevented from rotating relative to brake engagement structure 43. The locking member may be pressed away from the collet nut against the bias of spring 130 to tighten or loosen the collet nut on the collet. Alternatively, it will be appreciated that a variety of other locking mechanisms may be used to prevent collet nut 124 from self-loosening about collet 122.

As described above and in the incorporated references, safety system 18 includes a detection subsystem configured to detect one or more dangerous conditions such as contact between a person and the router bit, hazardous proximity of a person to the router bit, etc. Typically, router bit 98 is electrically insulated from motor assembly 16 and housing 84. It will be appreciated that the router bit may be electrically insulated in any of a variety of different ways. Various exemplary configurations and mechanisms for electrically insulating the cutting tool from the remainder of the machine are described in the incorporated references. As any of these configurations and mechanisms may be adapted for use with router 10, additional description will not be provided here. Likewise, various suitable configurations and mechanisms for monitoring the router bit and detecting contact, proximity, etc., are described in the incorporated references and, therefore, will not be described further herein. It will be understood that safety system 18 may incorporate any one or combination of the various alternative embodiments described in the references incorporated above.

Returning attention to FIG. 3, safety system 18 also includes a reaction subsystem 24 configured to stop the rotation of the router bit in the event the dangerous condition is detected. The reaction subsystem may be configured in any of a number of different ways. A variety of different exemplary reaction subsystems are described in the references incorporated herein, and may be adapted for use with router 10. Alternatively, FIG. 3 illustrates another exemplary embodiment in which reaction subsystem 24 includes at least one brake mechanism 28 having a brake pawl adapted to engage the brake engagement structure and stop the rotation of the brake engagement structure and router bit. While exemplary reaction subsystem 24 is described as having a single brake mechanism, it will be appreciated that the reaction subsystem may alternatively have a plurality of similar or different brake mechanisms as illustrated in FIG. 3.

Exemplary brake mechanism 28 includes a brake pawl 60 adapted to engage brake engagement structure 43 and stop the rotation of the brake engagement structure. Brake pawl 60 is biased to move into contact with and engage brake engagement structure 43 by a suitable biasing mechanism such as spring 66. The brake pawl is held spaced-apart from the brake engagement structure by a suitable restraining mechanism, such as a fusible member (not shown). A suitable release mechanism, such as a firing subsystem (not shown) is adapted to release the brake pawl from the restraining mechanism to move into contact with the brake engagement structure under the urging of spring 66. A variety of different exemplary brake mechanisms, biasing mechanisms, restraining mechanisms, and release mechanisms are described in the references incorporated herein. In addition, alternative actuators suitable for moving brake pawl 60 into contact with brake engagement structure 43 are described in U.S. Provisional Patent Application Serial U.S. Pat. No. 60/302,916, filed Jul. 3, 2001, the disclosure of which is herein incorporated by reference.

Brake pawl 60 is positioned adjacent the brake engagement structure to engage the edge of the brake engagement structure. In the exemplary embodiment, brake pawl 60 is mounted in a replaceable cartridge 80. A variety of alternative embodiments of cartridge 80 are described in the incorporated references. The cartridge is removably coupled to housing 84 to support the cartridge and brake pawl during braking. A portion 132 of cartridge 80 may be adapted to be received into a matching receptacle or socket in housing 84 to support the cartridge and electrically couple the cartridge to detection subsystem 22 and/or control subsystem 26. Control subsystem 26 may be configured to prevent operation of the router unless cartridge 80 is properly received in the socket. The cartridge is sized to ensure the brake pawl is aligned with the brake engagement structure when the cartridge is received in the socket. Optionally, safety system 18 may include a spacing detection system adapted to determine whether the brake pawl is at an acceptable spacing from the brake engagement structure, and to prevent operation of the router unless the brake pawl is properly spaced from the brake engagement structure.

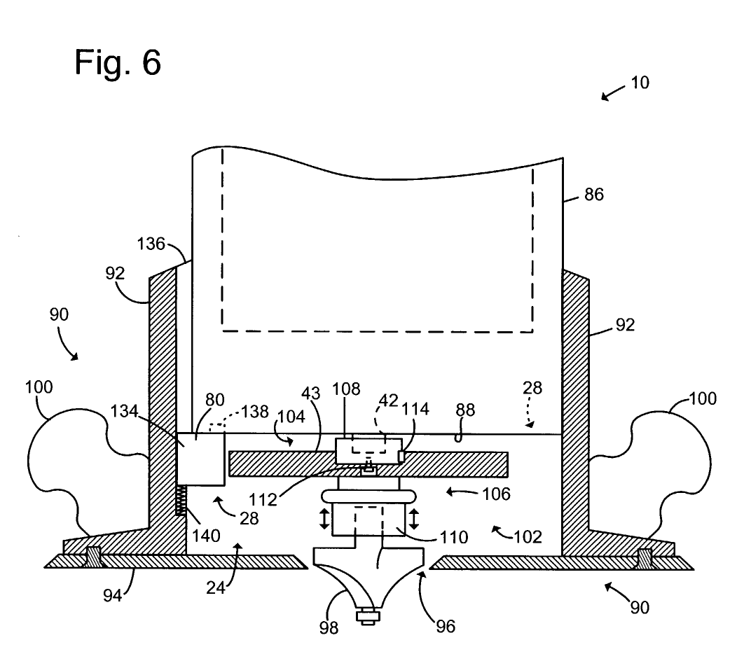

Alternatively, cartridge 80 may be coupled to base assembly 90 instead of, or in addition to, housing 84. For example, in the exemplary embodiment illustrated in FIG. 6, a portion 134 of the cartridge is adapted to be received within a channel 136 of shell 92. The base assembly holds the cartridge securely during normal operation and braking. A portion 138 of the cartridge may be adapted to engage a matching receptacle or socket in the router to electrically couple the cartridge to the detection subsystem and/or control subsystem. A biasing mechanism such as a spring 140 may be disposed in channel 136 to hold the cartridge against lower end 88 as the axial position of the base assembly is adjusted relative to housing 84. It will be appreciated that cartridge 80 may be coupled to the router housing and/or the base assembly by any other suitable coupling mechanism such as screws, clips, etc.

In some embodiments of safety system 18, brake pawl 60 and/or another component of the reaction subsystem may be a single-use component. Thus, in the event the brake mechanism is actuated to stop the router bit, the used cartridge is removed and a new cartridge is installed to place the router back in service. Alternatively, the single-use component within the cartridge may be replaced and the cartridge reinstalled. Brake engagement structure 43 may be either a single-use component or it may be reusable one or more times.

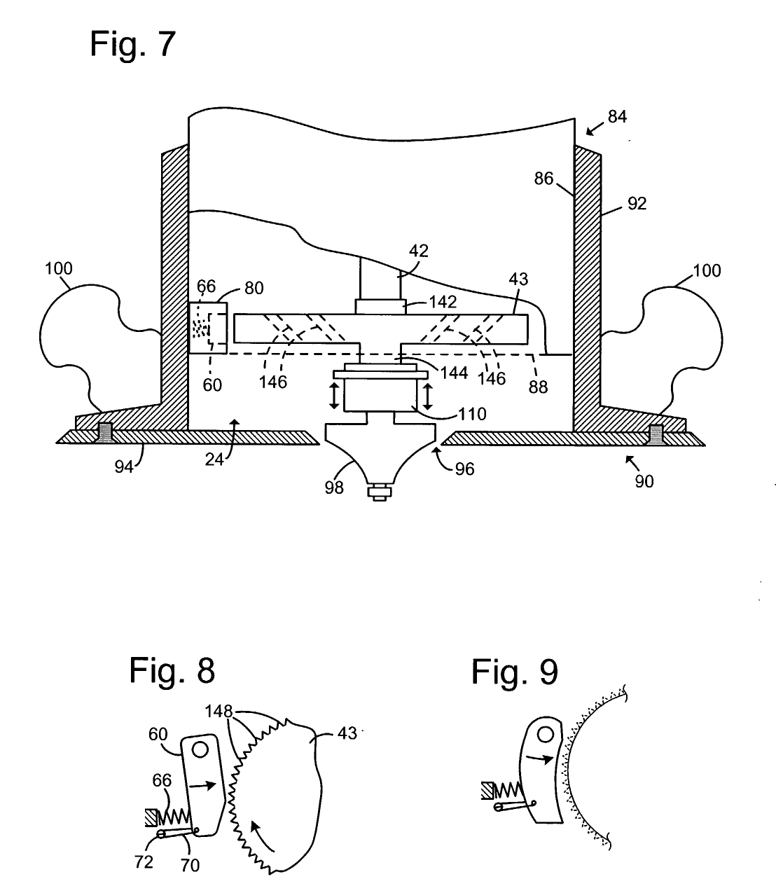

In the embodiments depicted in FIGS. 3-6, brake engagement structure 43 is positioned externally to housing 84. However, it will be appreciated that the brake engagement structure may alternatively be positioned within the housing. For example, FIG. 7 illustrates an embodiment in which brake engagement structure 43 is positioned within housing 84 adjacent lower end 88. One advantage of this configuration is that the rotating brake engagement structure and the brake pawl are not exposed outside of housing 84.

As shown in FIG. 7, brake engagement structure 43 is coupled to spindle 42 at a point inside housing 84 by a releasable coupling 142. The releasable coupling may be any suitable releasable coupling such as the torque-limiting couplings described above, or other releasable couplings known in the art. Alternatively, spindle 42 may include a torque-limiting mechanism adapted to uncouple a portion of the spindle proximate the brake engagement structure from the remainder of the spindle and motor assembly. As a further alternative, brake engagement structure 43 may be rigidly coupled to the spindle and brake mechanism 28 may be configured to stop the rotation of the spindle and motor armature. In the latter case, brake engagement structure 43 may be positioned at any point on spindle 42 including the opposite end of router 10 or a position between the opposing ends.

In any event, brake pawl 60 is configured to engage brake engagement structure 43 within housing 84. In the exemplary embodiment, cartridge 80 is adapted to be received into a matching socket or receptacle in housing 84 to position the brake pawl adjacent the edge of the brake engagement structure. Thus, the cartridge is securely supported by the housing and electrically coupled to the detection subsystem and/or the control subsystem. Optionally, the cartridge may be shaped to match the shape and contours of housing 84, thereby forming a portion of the exterior surface of the router housing when properly installed. Preferably, though not necessarily, the cartridge is configured to extend flush with, or behind, lower end 88 of housing 84 to allow the router to be mounted to a workpiece support surface (e.g., router table, etc.) without interference.

A portion 144 of brake engagement structure 43 extends through a hole in lower end 88 to couple to router chuck 110. Alternatively, a portion of the router chuck may extend through lower end 88 into housing 84 to couple to the brake engagement structure. In any event, chuck 110 is axially and rotationally coupled to the brake engagement structure to securely hold the router bit during both operation and braking. Chuck 110 may be coupled to brake engagement structure 43 by any suitable coupling mechanism such as described above. Similarly, chuck 110 may be any suitable router bit chuck or collet such as described above.

Optionally, brake engagement structure 43 may be configured to force air backward into housing 84, thereby eliminating the need (if any) for a separate air-cooling fan. For example, in the exemplary embodiment depicted in FIG. 7, brake engagement structure 43 includes one or more airflow channels 146 adapted to push air into housing 84 when the brake engagement structure is rotating. Thus, brake engagement structure 43 functions as the cooling fan for motor assembly 16 (i.e., the cooling fan is the brake engagement structure). It will be appreciated that airflow channels 146 may be sized and shaped as needed to achieve a desired airflow. In the depicted embodiment, airflow channels 146 are disposed inside the outer perimeter of brake engagement structure 43. However, it will be appreciated that the airflow channels may alternatively extend out to the perimeter of the brake engagement structure. Typically, airflow channels 146 will be configured and arranged to maintain the brake engagement structure in a balanced condition for smooth rotation.

As described above, brake mechanism 28 includes one or more braking components adapted to engage and stop brake engagement structure 43 and router bit 98. It will be appreciated that the particular configuration of the braking component will vary depending on the configuration of the brake engagement structure, and that various combinations of the braking component and brake engagement structure may be used. Typically, the braking component and the brake engagement structure are configured to ensure the brake mechanism stops the rotation of the brake engagement structure and router bit within a desired time period (“braking time”) after the dangerous condition is detected. The desired braking time may vary depending on the type of dangerous condition detected. For example, if the dangerous condition is contact between a person and the router bit, then a relatively short braking time is usually desirable to minimize any injury to the person. However, if the dangerous condition is proximity between the person and the router bit, then a somewhat longer braking time may be sufficient to prevent or minimize injury. Where contact is the dangerous condition detected, the brake engagement structure and braking component are preferably configured to achieve a braking time of approximately 10 milliseconds, and more preferably approximately 5 milliseconds. Where proximity is the dangerous condition being detected, the preferred braking time will depend on the distance between the person and the router bit at which proximity is detected. For instance, if proximity is detected when a part of the person's body is ⅛-inch from the router bit, then the braking time may be longer than if proximity is detected at a spacing of 1/32-inch.

In some embodiments brake pawl 60 and/or brake engagement structure 43 may include structure adapted to increase the grip or binding of the brake pawl and brake engagement structure. For example, the references incorporated herein describe many different alternative configurations of brake pawl 60 which may be suitable for engaging and stopping brake engagement structure 43. Many of the brake pawl configurations described in those references are adapted to engage and bind against a circular blade having a plurality of teeth disposed around the perimeter of the blade. The blade is usually constructed of a metal such as steel, while the brake pawl is constructed of a softer material which allows the teeth to cut into and wedge onto the brake pawl. Typical brake pawl materials include relatively high strength thermoplastics such as polycarbonate, ultrahigh molecular weight polyethylene (UHMW) or Acrylonitrile Butadiene Styrene (ABS), etc., or metals such as aluminum, etc. It will be understood that the term “brake pawl” is used herein generically to mean a braking component of any size, shape or configuration.

In the exemplary embodiment, depicted in FIG. 8, brake engagement structure 43 includes a plurality of gripping elements 148, which are similar to saw teeth. The brake pawl is biased by spring 66 to pivot into contact with the edge of the brake engagement structure so that gripping elements 148 engage the brake pawl. The brake engagement structure is constructed of a material having a greater hardness than the material of the brake pawl so that the gripping elements at least partially “bite” into brake pawl 60. Constructing the brake engagement structure from a material that is relatively durable and harder than the brake pawl material ensures that the brake engagement structure usually will not be damaged during braking. The exemplary brake pawl is sized and configured to ensure that the brake pawl does not pivot past the brake engagement structure without binding against the brake engagement structure and stopping its rotation.

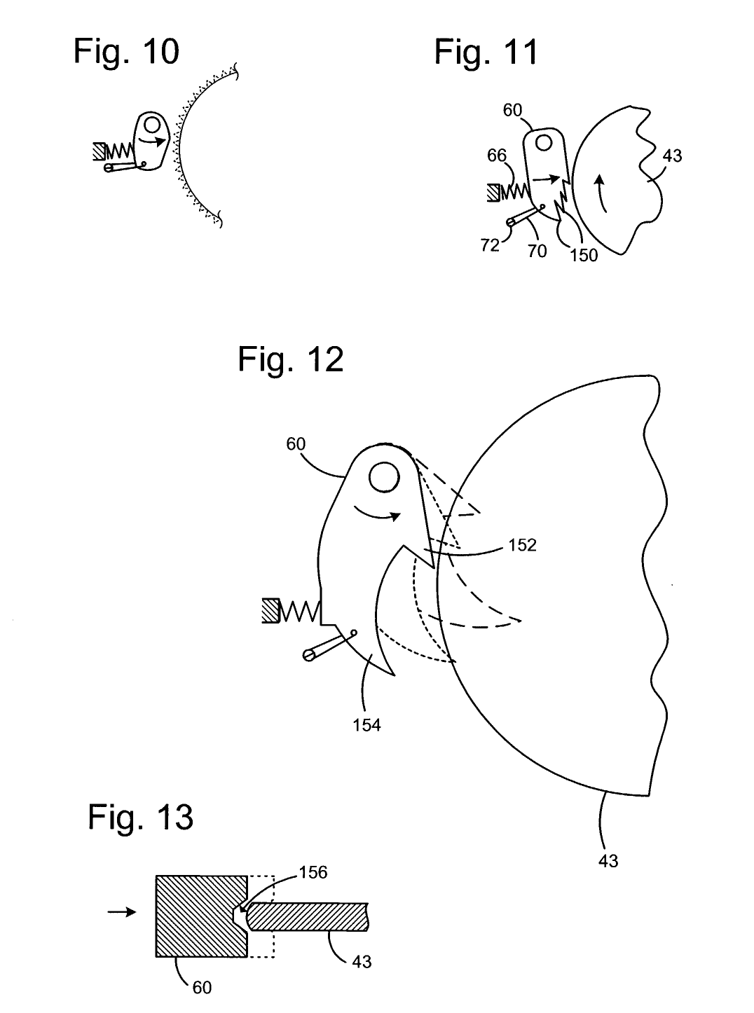

While one particular brake pawl shape is depicted, many different variations and modifications may be used. Additionally, it will be appreciated that the exact size and shape of gripping elements 148 is not critical, but instead may vary with the particular brake pawl. FIGS. 9 and 10 show just a few examples of alternative brake pawl shapes adapted to grip the brake engagement structure. The exemplary brake pawl depicted in FIG. 9 is shaped to generally conform to the perimeter of the brake engagement structure, thereby providing greater contact area between the brake pawl and brake engagement structure. The exemplary brake pawl depicted in FIG. 10 is shaped to form a cam wedge relative to the brake engagement structure to quickly bind against the brake engagement structure. Additionally, the alternative brake pawls described in the incorporated references may also be used to stop the rotation of the toothed brake engagement structure depicted in FIG. 8.

While the brake engagement structure described above is adapted to bite into the brake pawl, safety system 18 may alternatively be configured so that the brake component bites into the brake engagement structure to increase the binding action between the brake pawl and brake engagement structure. For example, FIG. 11 illustrates an embodiment in which brake pawl 60 includes one or more gripping elements 150 adapted to bite into brake engagement structure 43. In this embodiment, the brake pawl typically is constructed of a material having a greater hardness than the material of the brake engagement structure. For example, the brake pawl may be constructed of steel to engage a plastic or aluminum brake engagement structure, etc.

FIG. 12 illustrates another alternative embodiment in which brake pawl 60 includes at least one latching element 152 and at least one binding element 154. Latching element 152 is adapted to quickly contact and latch on to the rotating brake engagement structure, thereby imparting the energy of the brake engagement structure to the brake pawl. The speed and energy of the brake engagement structure is transferred to the brake pawl, causing the brake pawl to quickly pivot further into contact with the edge of the brake engagement structure. Thus, as illustrated in FIG. 12, the latching element ensures that the binding element is driven into the edge of the brake engagement structure to wedge in the brake engagement structure and quickly stop its rotation. While the edge of the brake engagement structure is illustrated as being smooth, it will be appreciated that the edge of the brake engagement structure may alternatively include gripping structure such as ridges, etc., adapted to prevent latching element 152 or binding element 154 from sliding around the edge of the brake engagement structure.

Brake pawl 60 and/or brake engagement structure 43 may also be shaped to increase the gripping action between the components instead of, or in addition to, other grip-enhancing structures. For example, FIG. 13 shows a cross-sectional view of an alternative brake engagement structure shaped to wedge within a channel 156 formed in the contacting surface of the brake pawl. As can be seen, channel 156 is tapered to a width that is less than the width of the brake engagement structure so that the upper and lower surfaces of the brake engagement structure will wedge against the upper and lower surfaces of the channel. It will be appreciated that channel 156 may be plural channels and/or may have any of a variety of shapes to match corresponding brake engagement structures. Alternatively, the brake pawl may be shaped to wedge within one or more channels formed in the brake engagement structure.

As described herein, safety system 18 provides an improved, active system for preventing or minimizing injuries from woodworking machines such as routers, etc. While several exemplary embodiments of safety system 18 are described above, the particular embodiments that have been described serve to illustrate that many different modifications and alterations are possible within the scope of the invention. It will be appreciated by those of skill in the art that safety system 18 may be adapted for use on a variety of other types of woodworking machines in addition to routers. Several examples of such other machines, as well as further detailed descriptions of alternative safety systems adaptable for use on routers may be found in the references incorporated above, as well as in the following references, the disclosures of which are herein incorporated by reference: PCT Patent Application Serial No. PCT/US00/26812, filed Sep. 29, 2000; U.S. patent application Ser. No. 09/676,190, filed Sep. 29, 2000; U.S. Provisional Patent Application Serial No. 60/292,100, filed May 17, 2001; U.S. Provisional Patent Application Serial No. 60/292,081, filed May 17, 2001; U.S. Provisional Patent Application Serial No. 60/279,313, filed Mar. 27, 2001; U.S. Provisional Patent Application Serial No. 60/275,595, filed Mar. 13, 2001; U.S. Provisional Patent Application Serial No. 60/275,594, filed Mar. 13, 2001; U.S. Provisional Patent Application Serial No. 60/273,902, filed Mar. 6, 2001; U.S. Provisional Patent Application Serial No. 60/273,178, filed Mar. 2, 2001; U.S. Provisional Patent Application Serial No. 60/273,177, filed Mar. 2, 2001; U.S. Provisional Patent Application Serial No. 60/270,942, filed Feb. 22, 2001; U.S. Provisional Patent Application Serial No. 60/270,941, filed Feb. 22, 2001; U.S. Provisional Patent Application Serial No. 60/233,459, filed Sep. 18, 2000; U.S. Provisional Patent Application Serial No. 60/225,210, filed Aug. 14, 2000; U.S. Provisional Patent Application Serial No. 60/225,058, filed Aug. 14, 2000; U.S. Provisional Patent Application Serial No. 60/225,057, filed Aug. 14, 2000; U.S. Provisional Patent application Serial No. 60/182,866, filed Feb. 16, 2000; U.S. Provisional Patent Application Serial No. 60/157,340, filed Oct. 1, 1999; and U.S. Pat. No. 4,267,914, issued May 19, 1981 to Saar.

We claim:

1. A router for cutting workpieces with one or more router bits, the router comprising:
an operative structure including a rotatable shaft;
a motor assembly coupled to rotate the shaft; and
a safety system configured to detect one or more dangerous conditions between a person and a router bit coupled to the operative structure, and configured to perform one or more predetermined actions in the event a dangerous condition is detected.

2. The router of claim 1, where the safety system includes a detection subsystem configured to detect accidental contact between a person and a router bit coupled to the operative structure.

3. The router of claim 2, where the detection subsystem is electrically coupled to the shaft to detect such accidental contact between a person and a router bit through the shaft.

4. The router of claim 2, where the safety system includes a reaction subsystem configured to stop the rotation of a router bit coupled to the operative structure in the event the detection subsystem detects accidental contact between a person and the router bit.

5. The router of claim 4, where the reaction subsystem is configured to stop the rotation of a router bit coupled to the operative structure within 10 milliseconds after the detection subsystem detects accidental contact between a person and the router bit.

6. The router of claim 1, where the safety system includes a reaction subsystem configured to engage at least a portion of the operative structure and stop the rotation of a router bit coupled to the operative structure.

7. The router of claim 6, where the operative structure includes a brake engagement structure coupled to rotate with the shaft, and where the reaction subsystem includes one or more braking elements configured to engage and stop the rotation of the brake engagement structure.

8. The router of claim 7, further comprising a housing assembly configured to enclose at least a portion of the motor assembly, and where the brake engagement structure is disposed external to the housing assembly.

9. The router of claim 7, further comprising a housing assembly configured to enclose at least a portion of the motor assembly, and where the brake engagement structure is disposed within the housing assembly.

10. The router of claim 7, where the operative structure includes a releasable coupling assembly configured to rotationally couple the brake engagement structure to the shaft, and where the releasable coupling assembly is configured to rotationally uncouple the brake engagement structure from the shaft under predetermined conditions.

11. The router of claim 10, where the releasable coupling assembly is configured to rotationally uncouple the brake engagement structure from the shaft when a predetermined torque load is applied to the releasable coupling assembly.

12. The router of claim 11, where the releasable coupling assembly is configured to rotationally re-couple the brake engagement structure to the shaft when the torque load applied to the releasable coupling assembly decreases to a predetermined level.

13. The router of claim 6, where the operative structure includes a releasable coupling assembly configured to receive a router bit and rotationally couple the router bit to the shaft, and where the releasable coupling assembly is configured to rotationally uncouple the router bit from the shaft under predetermined conditions.

14. The router of claim 13, where the releasable coupling assembly is configured to rotationally uncouple the router bit from the shaft when the reaction subsystem engages the operative structure.

15. A method of reducing injury to a person from a router bit rotationally driven by a router, the method comprising:
detecting accidental contact between a person and the router bit; and
stopping the rotation of the router bit if such accidental contact is detected.

16. The method of claim 15, where the router includes a motor assembly and the router bit is rotationally coupled to the motor assembly, and where the step of stopping includes rotationally uncoupling the router bit from the motor assembly.

17. The method of claim 16, where the step of stopping includes stopping the rotation of the router bit within 10 milliseconds after such accidental contact is detected.

18. A router for cutting workpieces with one or more router bits, the router comprising:
means for rotating a router bit;
means for detecting accidental contact between a person and the router bit; and
means for stopping the rotation of the router bit when such accidental contact is detected.

19. The router of claim 18, where the means for rotating includes a rotatable motor, and where the means for stopping includes means for stopping the rotation of the router bit independent of the rotation of the motor.

20. The router of claim 19, where the means for rotating includes means for releasably coupling the router bit to the motor.
